(19) United States
(12) Patent Application Publication
(10) Pub. No.: US 2014/0041379 A1
(43) Pub. Date: Feb. 13, 2014

(54) Master for a hydraulic actuating element

(71) Applicant: Gustav Magenwirth GmbH & Co. KG, Bad Urach (DE)

(72) Inventors: Stefan Ruckh, Romerstein (DE); Jochen Coconcelli, Metzingen (DE); Joachim Hujer, Grabenstetten (DE)

(73) Assignee: Gustav Magenwirth GmbH & Co. KG, Bad Urach (DE)

(21) Appl. No.: 14/058,726

(22) Filed: Oct. 21, 2013

Related U.S. Application Data
(63) Continuation of application No. PCT/EP2012/056424, filed on Apr. 10, 2012.

(30) Foreign Application Priority Data
Apr. 19, 2011 (DE) 10 2011 007 643.3
Jun. 30, 2011 (DE) 10 2011 078 480.2

(51) Int. Cl. B60T 11/16; B60T 7/10

(52) U.S. Cl. CPC B60T 11/165; B60T 7/102
USPC 60/594

(57) ABSTRACT

A master for a hydraulic actuating element, with a cylinder, in which a piston is displaceably mounted, and a hand lever, with which the position of the piston in the cylinder can be influenced, and a fastening element which comprises a clamping part shaped complementarily to the inner cross section of the handlebar, which is equipped for being fastened in the handlebar by means of an internal clamping. Furthermore, the invention relates to a master, in which the hand lever and the piston are connected by a push rod, which comprises a first longitudinal portion, which is provided with an external thread, which engages in an internal thread on the hand lever, so that the distance between piston and hand lever can be adjusted by turning the push rod, and wherein the push rod comprises a second longitudinal portion, which is provided with a polygonal outer cross section, which bears against at least one second spring element. Finally, the invention relates to a master, in which the piston made of a plastic material seals off the cylinder to the outside with a wiping lip, which is unitarily joined to the piston.

### CROSS REFERENCE TO RELATED APPLICATION

This is a continuing application, under 35 U.S.C. §120, of copending international application No. PCT/EP2012/056424 filed on Apr. 10, 2012, which designated the United States and was not published in English; this application also claims the priority, under 35 U.S.C. §119, of German Patent Application Nos. 10 2011 007 643.3 filed on Apr. 19, 2011 and 10 2011 078 480.2 filed on Jun. 30, 2011; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The invention relates to a master for a hydraulic actuating element, with a cylinder, in which a piston is displaceably mounted, and a hand lever, with which the position of the piston in the cylinder can be influenced.

### BACKGROUND OF THE INVENTION

German Patent Application DE 42 32 766 A1 discloses a generic master. This master is fastened to the handlebar of a bicycle by a clamp. Through a hand lever, force can be exerted on a piston to pressurize hydraulic fluid located in the interior of the cylinder. The master is connected through a pressure line to a slave cylinder, which can be moved by the hydraulic fluid and generate a braking force. This known master has a number of disadvantages. On the one hand, the handlebar of the bicycle can be damaged by the clamp. Because of this, the handlebar can fracture in an uncontrolled manner and, as a result, endanger the user of the bicycle. Furthermore, the master is fastened to the handlebar on the outside in an exposed position. This means that it can be damaged during a fall. The removal of the wheel is impeded in that the tire, as a rule, protrudes over the rim and, thus, cannot be guided past the brake lining. For this reason, before removing the wheel, either the air has to be drained from the tire or the slave cylinder with the brake lining fastened thereto has to be disassembled. Finally, upon wear of the brake lining, the backlash of the brake lever can increase, so that the full brake power cannot be accessed at all or only with a delay.

### SUMMARY OF THE INVENTION

The invention provides a master for a hydraulic actuating element that makes possible a comfortable disassembly of the wheel and/or offers an elevated safety level.

According to the invention, a master for a hydraulic actuating element is proposed. The hydraulic actuating element comprises a slave cylinder, which can generate a force as a function of the pressure in a hydraulic system, in order to operate a function element of a vehicle. For example, the hydraulic actuating element can be part of a rim brake, a disk brake, or a drum brake. In other embodiments of the invention, the hydraulic actuating element can be part of a clutch or a transmission.

To be able to control the actuating element through user intervention, the proposed master comprises a cylinder in which a piston is displaceably mounted. The position of the piston within the cylinder can be influenced through a hand lever. Thus, the inner volume of the cylinder becomes larger or smaller as a function of the position of the hand lever and, accordingly, the pressure prevailing in the hydraulic system becomes lower or greater.

To enable a vehicle driver or the user of the vehicle to operate the master without taking his hands off the handlebar of the handlebar-guided vehicle, it is also provided in some embodiments of the master according to the invention, the latter has a fastening element for fastening to the handlebar. A handlebar-guided vehicle in terms of the present invention can, for example, be a bicycle, a motorcycle, a snow mobile, a quad, a trike, or a similar vehicle.

In some embodiments of the invention, the fastening element comprises a clamping part shaped complementarily to the inner cross section of the handlebar, which is equipped for being fastened in the handlebar by means of an internal clamping. A shape that is complementary to the inner cross section of the handlebar in terms of the present description is to mean any shape that can be inserted into the interior of the handlebar. This need not necessarily require as a prerequisite that both cross sections have approximately the same area or the same shape. For example, one of the cross sections can be polygonal and the other cross section, round. Insofar as both cross sections are embodied round, these need not necessarily have the same radius or diameter. It is merely important for the mode of operation of the invention that the clamping part can be received in the interior of the handlebar and fixed there.

The fixation, in some embodiments of the invention can be imparted through at least one clamping device, which is arranged on the circumferential surface of the clamping part. The clamping device can be embodied in one part or multiple parts. In some embodiments of the invention, the clamping device can contain at least one wedge and/or a spring and/or a clamping screw. In other embodiments of the invention, the fixation can be effected through a locking device running transversely to the longitudinal extension of the handlebar. In other embodiments of the invention, the clamping part can be held in the interior of the handlebar through a sliding or press fit. In yet another embodiment of the invention, the clamping part can be received in the interior of the handlebar through positive connection using a casting compound or a clamping element of variable size. This embodiment avoids exerting a clamping force acting on the handlebar from the outside so that the handlebar cannot be damaged through such a clamping force. This is helpful, in particular, in the case of handlebars that are of a fiber-reinforced plastic or contain a fiber-reinforced plastic. Furthermore, the proposed master can be mounted to a handlebar without obstructing the grip position through clamps attached on the outside.

In one embodiment of the invention, there is provided a master for a hydraulic actuating element, with a cylinder, in which a piston is displaceably mounted, the position of which in the cylinder can be influenced through a hand lever. To prevent the entry of dirt, the piston can seal off the cylinder to the outside with a wiping lip. According to the invention, it is now proposed to join the wiping lip unitarily to the piston, i.e., to produce the piston and the wiping lip from a single piece of material. The piston with integrated wiping lip can, in some embodiments of the invention, be produced through injection molding or through cutting material processing. In some embodiments, the piston can be produced as a turned part.

In some embodiments of the invention, the piston can contain or be of polyoxymethylene and/or polyethylene and/or polyether ketone and/or polytetrafluoroethylene. These plastics allow simple processing by cutting and an adequate elasticity of the wiping lip so that the latter can bear against the inner wall of the cylinder in a sealing manner following the assembly of the piston in the cylinder. Through the unitary production, separation of the wiping lip from the piston and consequential loss are avoided. In some embodiments of the invention, the gap between the wiping lip and the piston can be avoided so that no dirt or moisture can enter there.

In some embodiments of the invention, the master can comprise a cylinder, in which a piston is displaceably mounted, wherein its position within the cylinder can be controlled by a hand lever. According to the invention, it is now proposed to connect the hand lever and the piston using a push rod, which comprises a first longitudinal portion, which is provided with an external thread. This first longitudinal portion engages in a complementary internal thread on the hand lever so that the distance between piston and hand lever or the effectively acting length of the push rod can be adjusted by turning the push rod.

To avoid unintentional turning and, thus, an unintentional length change of the push rod during operation, the push rod comprises a second longitudinal portion, which is provided with a polygonal outer cross-section. The polygonal outer cross-section bears against at least one second spring element. Because of this, the spring element exerts a force on the push rod, which prevents unintentional twisting. Insofar as the push rod is twisted through user intervention, this leads to the deformation of the spring element so that the push rod can be twisted in an engaging manner corresponding to the number of external flats of the polygonal cross-section. If the polygonal cross-section, for example, comprises three external flats, the push rod can be twisted in 120° steps. A polygonal cross-section with six corners allows the twisting of the push rod in 60° steps. The number of corners of the polygonal cross-section can be selected corresponding to the pitch of the thread, so that the length of the push rod can be adjusted sufficiently finely.

Because the hand lever assumes a defined position on the master, the volume of the cylinder with zero position of the hand lever can be adjusted through the length of the push rod. This has a direct effect on the position of the slave piston of the hydraulic actuating element so that through the length of the push rod, for example, a lining wear of a brake or clutch lining, can be adjusted. This makes possible a braking action that remains the same with increasing wear of the brake lining and, thus, a secure deceleration of the vehicle up to the complete lining wear.

In some embodiments of the invention, the spring element can be produced from a metal or an alloy and, for example, have the geometry of at least one leaf spring, which is guided against the polygonal outer cross-section of the push rod. In other embodiments of the invention, the spring element can be an elastomer, which surrounds the push rod or which is guided at least on one side against the push rod.

In some embodiments of the invention, at least two spring elements can be employed, which elements engage around the push rod on both sides, to avoid the occurrence of a bending moment on the mounting unit of the push rod. This allows a simple adjustability with minor actuation forces and a long lifespan of the master.

In some embodiments of the master, which can be fastened to the handlebar through internal clamping, this internal clamping is imparted through at least one leaf spring, which is disposed on the circumferential surface of the clamping part. Such a leaf spring can be employed to offset tolerances of the internal diameter of the handlebar so that the proposed master can be universally employed on different handlebars. In other embodiments of the invention, the leaf spring can be employed to adapt the internal clamping of the master to different handlebars so that different handlebars with different internal diameters become compatible with the proposed master.

In some embodiments of the invention, the internal clamping furthermore can comprise at least one adjusting device, by which the preload of the leaf spring can be influenced, after the clamping part has been inserted in the handlebar. This allows assembly in the relaxed state and a subsequent tensioning of the leaf spring so that the inner cross-section of the handlebar is not damaged through insertion. The assembly is facilitated, furthermore, because the master can be inserted into the interior of the handlebar free of force and tension and is only clamped to the interior of the handlebar in its final assembly position.

In some embodiments of the invention, the at least one cylinder can be at least partially disposed in the interior of the clamping part. Because of this, the cylinder is protected in the interior of the handlebar, so that the latter can be damaged less easily during a fall or falling over of the vehicle. Because of this, the discharge of hydraulic fluid is also avoided, which in some embodiments of the invention, can be caustic or toxic.

In some embodiments of the invention, the master contains a connection for a hydraulic line that is disposed on the clamping part. This allows the hydraulic line to be routed at least in certain sections in the interior of the handlebar, where it is less visually interfering, protected against damage, and has a lower air resistance.

In some embodiments of the invention, the hand lever in its rest position or zero position can be located either on a first stop or on a second stop, wherein the first stop is defined by a first position of a moveable stop element and the second stop is defined by a second position of the moveable stop element. Because of this, the hydraulic cylinder can have a first volume when the hand lever is located on the first stop and a second volume when the hand lever is located on the second stop. Here, the second volume is larger than the first volume. Accordingly, the hydraulic actuating element is located in different rest positions, depending on whether the hand lever bears against the first or second stop. Insofar as the actuating element comprises a brake, the brake linings can have a greater distance from the rotating friction partner when the hand lever is located on the second stop. Because of this, the removal of the wheel and/or of a brake disk can be facilitated.

In some embodiments of the invention, the master furthermore comprises a first spring element, which acts on the stop element and during a movement of the hand lever from the second stop to the first stop brings the stop element from the second position into the first position. This embodiment of the invention makes possible the unlocking of the hand lever by the user so that the hand lever remains on the second stop thereafter. Insofar as this position defines a wheel removal position, the wheel can be disassembled in a simple manner without the brake linings impeding this removal. After the reinstallation of the wheel, the hand lever again engages on the first stop during the initial actuation, without the user having to operate the stop element. Thus, this operation cannot be inadvertently forgotten either and the brake is automatically located in its operating position again without further user intervention. Unlike previous hydraulic brakes, in which, in most cases, a slave cylinder had to be disassembled in order to make possible the wheel removal, the restoration of the operational readiness of the brake following the reinstallation of the wheel cannot be forgotten, which increases the safety of the user of the vehicle.

In some embodiments of the invention, the master furthermore contains at least one sliding piece, which is displaceable in the axial direction and is in contact with a clamping wedge. The sliding piece in this embodiment of the invention can transmit the radial force component of the clamping wedge to the basic body. Because the sliding piece is moveable, it can fulfill this task for different positions of the clamping wedge and, thus, for different handlebar diameters.

In some embodiments of the invention, the sliding surface on the basic body is inclined against the longitudinal axis of the clamping part to subject the clamping wedge during an axial displacement on the sliding surface to a radial position change. In some embodiments of the invention, the sliding piece is in contact with the clamping wedge through an inclined contact surface so that the clamping wedge during an axial displacement of the sliding piece is subjected to a radial position change. In some embodiments of the invention, the contact surface and/or the sliding surface is inclined by approximately 15° to approximately 60° against the longitudinal axis of the clamping part. In some embodiments of the invention, the contact surface and/or the sliding surface is inclined by approximately 25° to approximately 35° against the longitudinal axis of the clamping part. Through at least one inclined sliding surface, an axial movement of a clamping element can be converted into a radial movement to make adjustable the clamping force by adjusting the axial travel. The axial movement can, in some embodiments of the invention, be imparted through a spring and/or a threaded rod. By way of the inclination angle, a transmission ratio of the movements can, in this case, be set so that a minor assembly force is sufficient for generating a large clamping force.

In some embodiments of the invention, the adjusting device comprises a threaded pin, which is received in an associated threaded bore in the basic body, wherein the force transmission from the threaded pin to the clamping wedge and/or the sliding piece is effected through a cylindrical pin. The cylindrical pin in this case can have a smaller diameter than the threaded pin so that this embodiment of the invention saves installation space, which can either be utilized for an enlargement of the hydraulic cylinder or an enlargement of the clamping elements.

In some embodiments of the invention, the basic body comprises at least one recess, in which the clamping wedge and/or the sliding piece is received. Because of this, the mechanics of the clamping device can be disposed in a space-saving manner so that a largely smooth surface outer contour of the clamping part is obtained.

In some embodiments of the invention, the master contains at least one spring clip, with which a spring force acting at least in the radial direction can be exerted on the clamping wedge. This spring force can be employed as a resetting force to make possible a simple disassembly of the master from the handlebar tube. In addition or alternatively, the spring force can serve for assembly facilitation because loose individual parts are held together by the spring before the insertion of the clamping part in the handlebar.

In some embodiments of the invention, the clamping part has a substantially cylindrical basic shape, wherein the cross-section of the recess is delimited by two load receiving areas running substantially radially and a base area with a first radius, wherein the cross-section of the sliding piece in at least one longitudinal portion has the shape of an annulus sector, whose inner surface has a second radius, wherein the second radius is smaller than the first radius. In terms of the present description, the load receiving areas are considered to be running substantially radially when the deviation from the radial direction is less than approximately 30° or less than approximately 20° or less than approximately 10°.

Although the invention is illustrated and described herein as embodied in a master for a hydraulic actuating element, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a fragmentary, elevational view of a first embodiment of a master according to the invention prior to the assembly on a handlebar;

FIG. 2 is a fragmentary, elevational view of the master of FIG. 1 after assembly on the handlebar;

FIG. 3 is a fragmentary, perspective view of the master of FIG. 2;

FIG. 4 is a fragmentary, cross-sectional view through the master of FIG. 2;

FIG. 5 is a fragmentary, front elevational view of the master of FIG. 2;

FIG. 6 is a cross-sectional view through an exemplary embodiment of a piston according to the invention that can be used with the master of FIG. 1;

FIG. 7 is a partially cross-sectional view of an exemplary embodiment of a push rod according to the invention that can be used with the master of FIG. 1;

FIG. 8 is a fragmentary elevational view of an interaction of the push rod of FIG. 7 with an exemplary embodiment of a spring element according to the invention;

FIG. 9 is a perspective view of a basic body of another exemplary embodiment of a master according to the invention prior to the assembly on a handlebar;

FIG. 10 is an elevational view of a master according to the invention with the basic body of FIG. 9 prior to the assembly on the handlebar;

FIG. 11 is a cross-sectional view through the clamping part of the second embodiment along section line D-D in FIG. 10;

FIG. 12 is an enlarged cross-sectional view through the master of FIG. 10 along section line A-A through the clamping part;

FIG. 13 is an exploded, perspective view of the master of FIGS. 9 and 10;

FIG. 14 is a fragmentary, diagrammatic cross-sectional view of a first exemplary variant of a clamping part of the master according to FIGS. 9 and 10;

FIG. 15 is a fragmentary, diagrammatic cross-sectional view of a second exemplary variant of a clamping part of the master according to FIGS. 9 and 10;

FIG. 16 is a fragmentary, diagrammatic cross-sectional view of a third exemplary variant of a clamping part of the master according to FIGS. 9 and 10;

FIG. 17 is a fragmentary, diagrammatic cross-sectional view of a fourth exemplary variant of a clamping part of the master according to FIGS. 9 and 10;

FIG. 18 is a cross-sectional view of a third exemplary embodiment of a master according to the invention in a first position; and

FIG. 19 is a cross-sectional view of the master of FIG. 18 in a second position.

### DETAILED DESCRIPTION OF THE EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

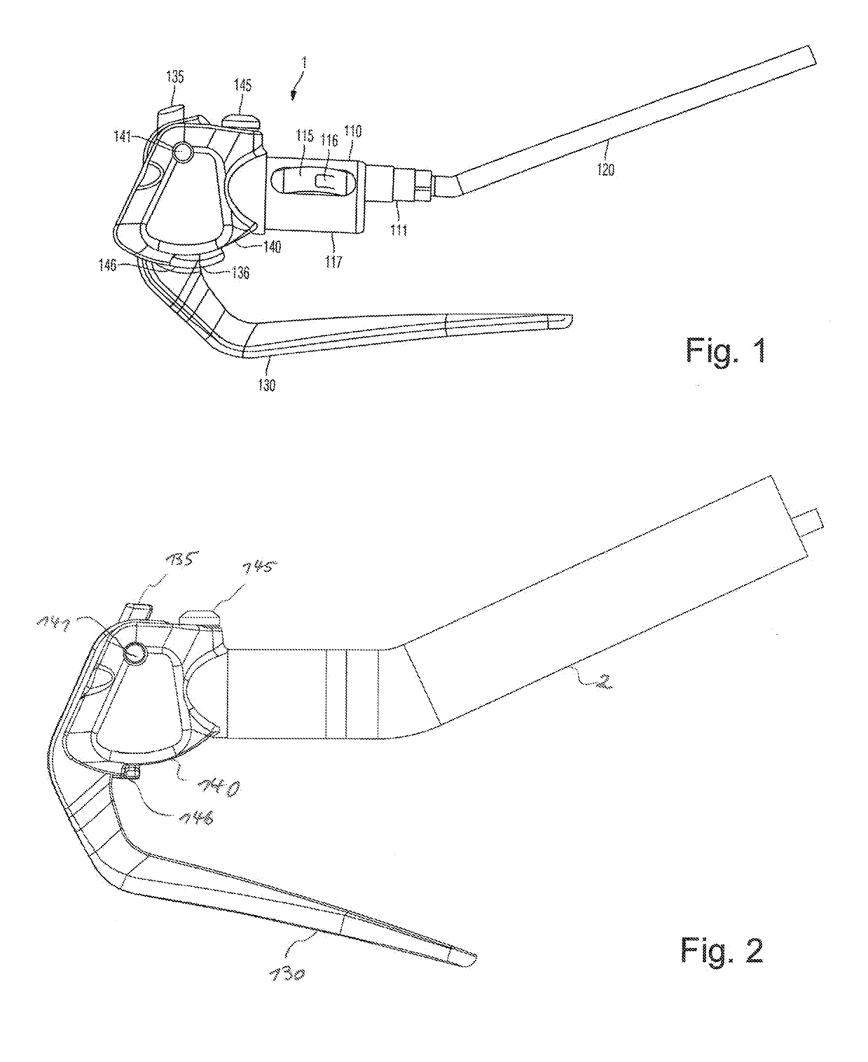

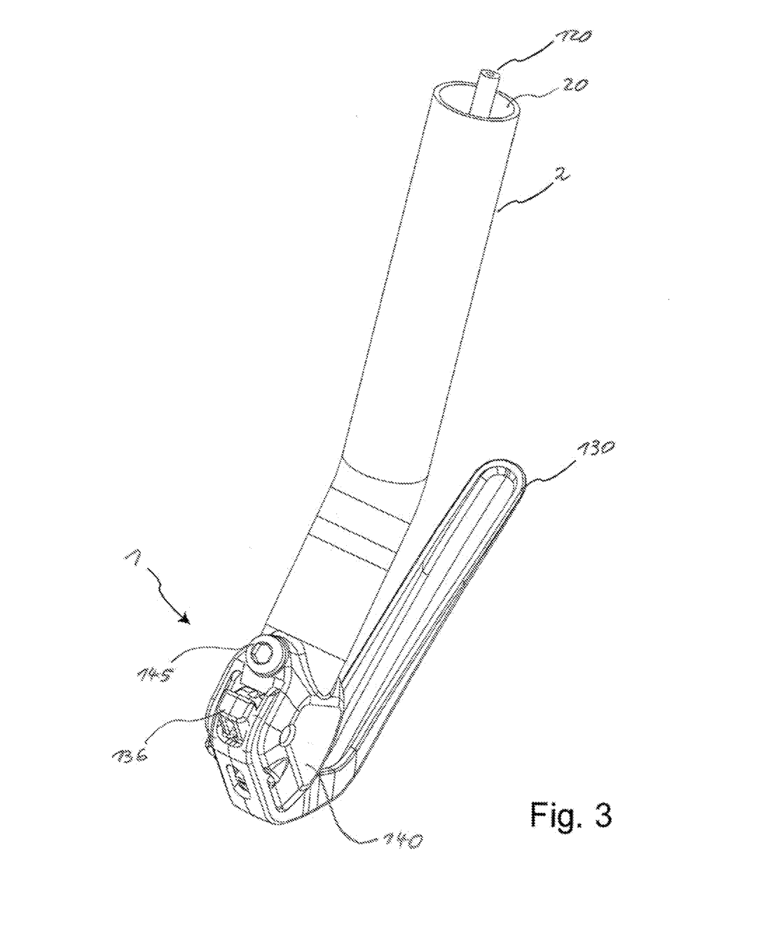

Described now are exemplary embodiments of the present invention. Referring now to the figures of the drawings in detail and first, particularly to FIGS. 1 to 5, there is shown a first exemplary embodiment of a master according to the invention. The master 1 comprises a basic body 140 fastened to the handlebar 2 of a handlebar-guided vehicle with a fastening element. The fastening element in this case is embodied as a clamping part 110, which is inserted in the inner cross-section 20 of the handlebar 2. Following the insertion of the clamping part 110 in the handlebar 2, the clamping part 110 can be clamped in the interior of the handlebar 2 through at least one leaf spring 115, so that the master is reliably mounted on the handlebar 2. In some embodiments of the invention, a plurality of leaf springs 115 can be disposed on the circumferential surface of the clamping part 110. For example, two to four leaf springs 115 can be provided in order to make available, on the one hand, a sufficient clamping force and, on the other hand, to not render the assembly more difficult through too large a number of leaf springs 115. In one exemplary embodiment of the invention, two leaf springs 115 can be present, which are located on the circumferential surface of the clamping part 110 less than 180° apart, so that the clamping part bears against the inner cross-section 20 of the handlebar 2 in three defined locations.

In the shown exemplary embodiment, the inner cross-section 20 is configured to be round and the clamping part 110 cylinder-shaped with a smaller outer diameter than the inner diameter of the handlebar 2. In other embodiments of the invention, the inner cross-section 20 and/or the clamping part 110 can also have a different cross-section, for example, a polygonal or elliptical cross-section. Important merely is the insertability of the clamping part 110 in the handlebar 20. The invention does not teach a defined cross-section as solution principle.

In the shown exemplary embodiment, the leaf spring 115 has an outwardly curved shape, so that it reliably bears against the inner cross-section 20. The curvature radius and, thus, the preload of the leaf spring 115 can be adjusted through adjusting devices 112, which are also accessible from the outside after the insertion of the clamping part 110 in the handlebar 2, as is evident on the basis of FIG. 5.

The leaf spring 115 can comprise at least one optional slit 116, which clears a part area 117 from the rest of the area of the spring. Because of this, the holding force of the leaf spring 115 in the handlebar 2 can be increased.

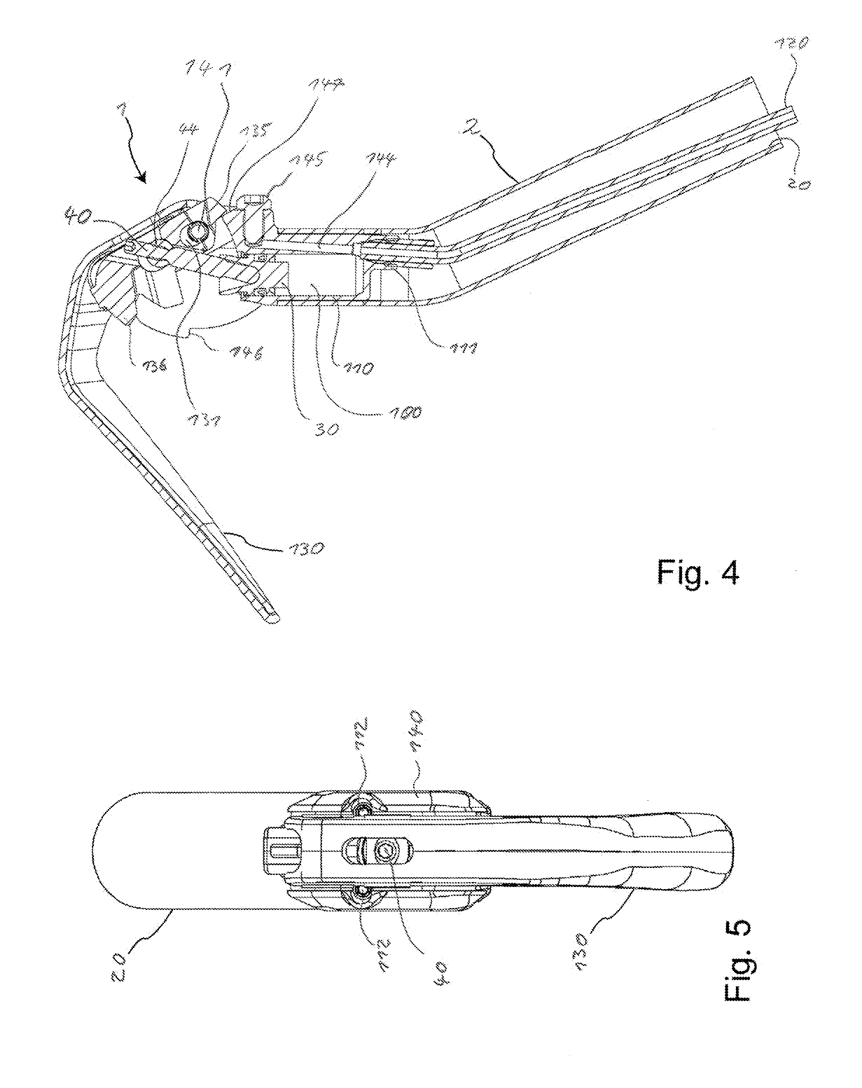

As is best visible in the cross-section of FIG. 4, the cylinder 100 with the piston 30 displaceably mounted therein is disposed in the interior of the clamping part 110 so that it is protected by the handlebar 2 from damage through the action of mechanical forces and/or weather influences.

The cylinder 100 leads into a connection 111, to which a hydraulic line 120 is connected, which connects the proposed master to the slave of a hydraulic actuating element, for example, a brake or a clutch. Because of this, the hydraulic line 120 can be routed in the interior of the handlebar 2 at least in certain sections, where the line 120 is installed in the vehicle aerodynamically advantageously and protected from damage.

Because air inclusions in the interior of the cylinder 100 or the hydraulic line 120 can lead to malfunctioning, the master 1 has a vent bore 145. The vent bore 145 can be closed off with a screw in operation. So that the vent bore 145 and the screw are accessible in the operating position of the master 1, these are connected to the cylinder 100 or the hydraulic line 120 with a connecting channel 144. This channel 144 allows venting of the hydraulic system without disassembly of the master.

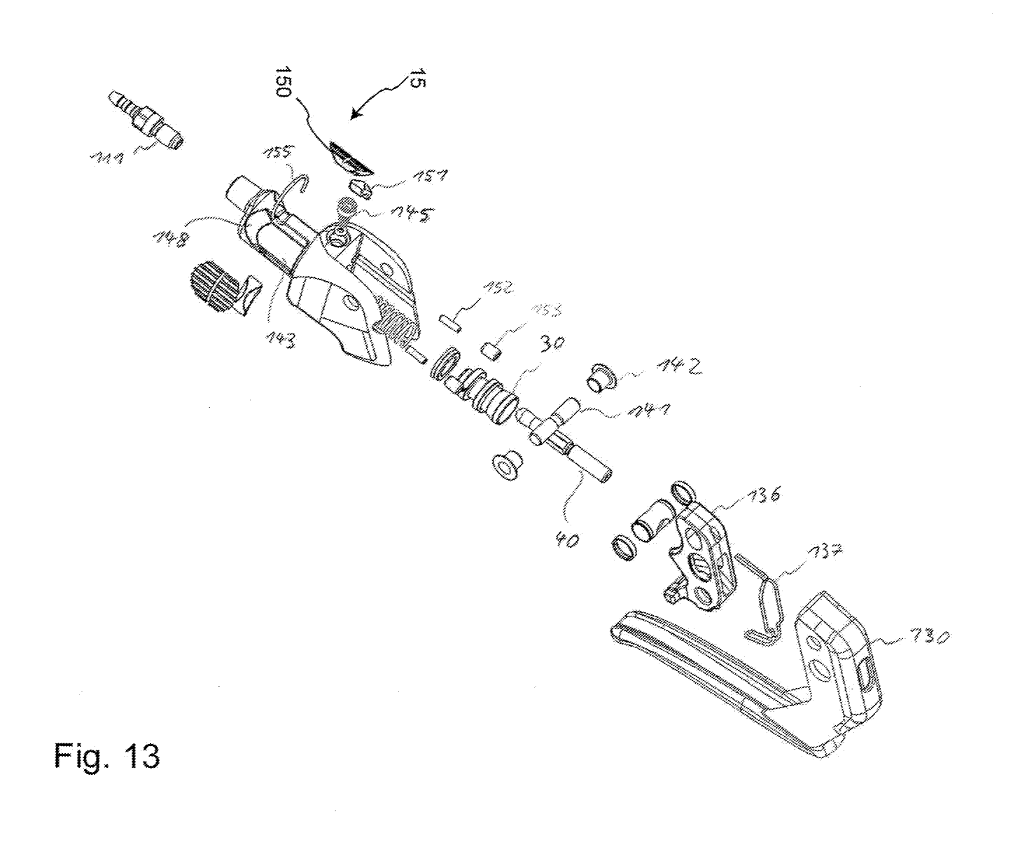

To pressurize the hydraulic fluid in the cylinder 100, a piston 30 is displaceably mounted in the cylinder 100. The piston 30 is fastened to a hand lever 130, which is rotatably or pivotably received on the basic body 140 by means of an axle 141. For fastening the axle 141, pressed-in bearing shells 142 can be used (see FIG. 13). The connection between the piston 30 and the hand lever 130 is imparted by a push rod 40. The zero position of the piston 30 and, thus, the volume of the cylinder 100 and the zero position of the actuating element, for example, of the brake, are defined by the effective length of the push rod 40. To be able to adjust the zero position in a simple manner, the push rod 40 has a first longitudinal portion 401, which is provided with an external thread. This external thread is received in a complementary internal thread 44 on the hand lever 130 so that, by rotating the push rod 40, a relative position of the push rod 40 to the hand lever 130 can be adjusted. As is evident from FIG. 5, the face end of the push rod 40 is accessible from the outside, so that it can be turned with a suitable tool.

The hand lever 130 is furthermore in contact with a moveable stop element 136. In the operating position, shown in FIGS. 1, 2 and 3, the stop element 136 bears against the first stop 146 of the basic body 140. The operating position allows the actuation of the hydraulic actuating element (for example a brake) with a minor backlash, so that the reaction time is minimal. During maintenance operations (for example, a removal of a wheel), the moveable stop element 136 can be brought out of a first position shown in FIG. 1 into a second position, which is shown in FIG. 4. In this second position, the stop element 136 bears against the second stop 147 of the basic body 140. In this position, the hand lever 130 is further pivoted away from the handlebar 2 and the piston 30 is in a further retracted position. This results in a larger volume of the cylinder 100 and, thus, to a correspondingly changed position of the slave cylinder (for example, of the brake). To bring the moveable stop element 136 from the first position into the second position, it can be displaced out of its rest position against a spring force through the push button 135, so that it releases the first stop 146 on the basic body 140. When the master 1 is actuated out of the position shown in FIG. 4 for the first time, the stop element 136 can be moved again into the starting position through the spring force so that it subsequently bears against the first stop 146 again and the normal operating position of the piston 30 in the cylinder 100 is reassumed. The spring force can be applied by a spring 137 (see FIG. 13). Because of this configuration, the hydraulic actuating element (which is activated by the master according to the invention) unintentionally remaining in the maintenance position after completion of the maintenance operations, in which the function can be restricted, is avoided.

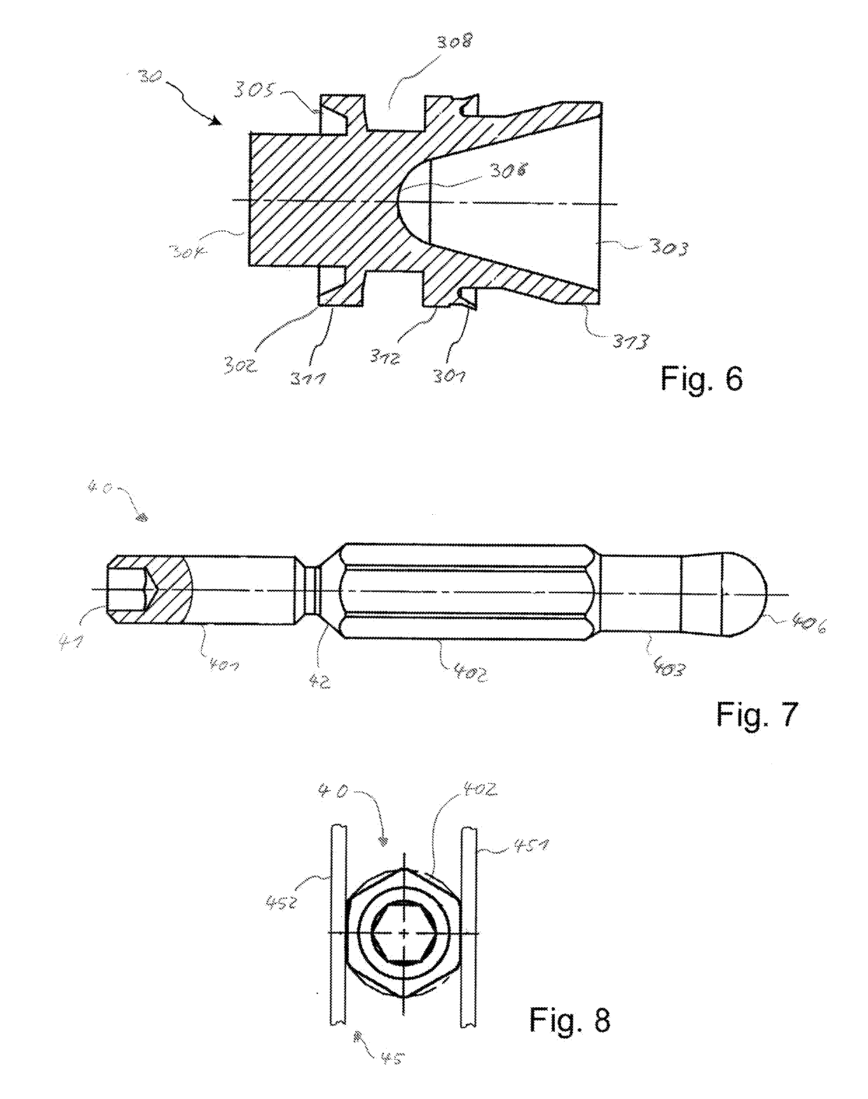

FIG. 6 shows an embodiment of a piston 30, which can be used with a master known per se or with the master shown in FIGS. 1 to 5. The piston 30 according to FIG. 6 comprises a substantially cylindrical basic shape. On one side of the basic shape, a substantially conical recess 303 is present, which terminates in a spherical base 306. The recess 303 serves to receive a push rod, with which the force of a hand lever can be transmitted to the piston so that its position within the cylinder and, thus, the pressure prevailing in the cylinder can be influenced by the hand lever. Located opposite the recess 303 is an end face 304, which, in the exemplary embodiment according to FIG. 6, is flat and which displaces the hydraulic fluid from the cylinder 100 and, thus, sets the hydraulic actuating element in motion.

When the piston 30 is inserted in a cylinder 100, the piston 30 bears with three bearing surfaces 311, 312 and 313 in the cylinder. Because of this, the piston 30 is guided so that torques exerted on the piston 30 do not lead to the jamming of the piston 30 in the cylinder. In some embodiments of the invention, at least one bearing surface can be enlarged by an optional protrusion 302, as is exemplarily shown by the first bearing surface 311. Because of this, the jamming tendency of the piston 30 in the cylinder 100 is further reduced.

The protrusion 302 further delimits a receiving space 305, in which a spring element can be received, which moves the piston 30 back into its starting position after the actuation of the hand lever 130.

Furthermore, a groove 308 is in the outer cross-section of the piston 30, which groove 308 is provided for receiving a non-illustrated seal. In some embodiments of the invention, the seal can be an O-ring seal or an X-seal.

To prevent the entry of dirt and/or water into the interior space of the cylinder 100 or the seal in the groove 308, a wiping lip 301 is disposed on the second bearing surface 312. The wiping lip 301 is unitarily joined to the piston 30. To this end, the piston 30 can be produced from a plastic material through cutting, for example, as a turned part. The unitary embodiment of the wiping lip 301 allows a reliable sealing between the wiping lip 301 and the piston 30 and a simple produceability. Furthermore, the wiping lip 301 cannot get lost before and during the assembly of the piston 30 in the cylinder 100.

FIG. 7 shows an exemplary embodiment of a push rod 40, with which the piston 30 can be connected to the hand lever 130. The push rod 40 comprises a first longitudinal portion 401, which is provided with an external thread and which is in engagement with the hand lever 130.

Following this, the push rod 40 comprises a longitudinal portion 402, which has a polygonal outer cross-section. This second longitudinal portion 402 serves as an anti-rotation device, which is explained in more detail in the following on the basis of FIG. 8.

FIG. 8 shows the front view of the cross-section of the push rod according to FIG. 7. The longitudinal portion 402 of the push rod 40 is in engagement with a spring element 45, which exerts a force on at least one area of the polygonal cross-section of the longitudinal portion 402. In the shown exemplary embodiment, the spring element 45 is in two parts and comprises a first leaf spring 451 and a second leaf spring 452. Because of this, the push rod 40 is prevented from unintentional turning, which can occur, for example, through vibrations during the operation of the vehicle. Because of the thread in the first longitudinal portion 401, such an unintentional turning would lead to a length change of the distance between the hand lever 130 and the piston 30 and, thus, to an undesirable adjustment of the hydraulic actuating element.

However, if the user wishes to adjust the hydraulic actuating element, he can turn the push rod 40 against the force of the spring elements 45 with a suitable tool, which is introduced into the tool receptacle 41. The tool receptacle 41 can have an internal hexagon or an internal splines profile.

Finally, the push rod 40 comprises a third longitudinal portion 403, which terminates in a spherical collar 406. The third longitudinal portion 403 engages in the recess 303 on the piston and, thus, ensures the force transmission from the hand lever 130 to the piston 30.

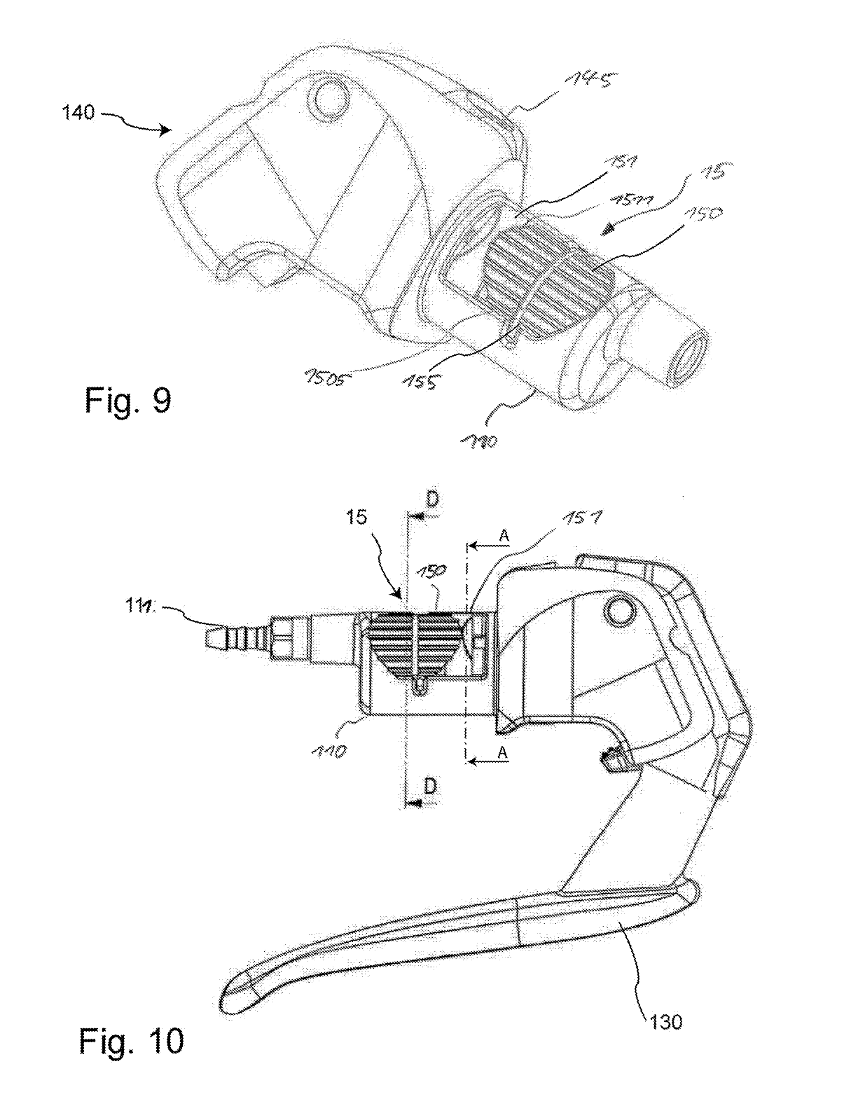

On the basis of FIGS. 9 to 13, a second exemplary embodiment of the invention is explained in more detail. Identical components of the master according to the invention are denoted by the same reference numbers. The following description is, therefore, restricted to the differences to the first embodiment already described above.

One difference of the second embodiment lies in the features of the clamping part 110 inserted in the handlebar and there, in particular, in the embodiment of the clamping device 15. The clamping device 15 comprises a clamping wedge 150, whose radial distance from the center axis of the clamping part 110 is adjustable, in order to achieve an internal clamping in different handlebar diameters in this way. The radial distance of the clamping wedge 150 from the center axis of the clamping part 110 is influenced by way of the position of a sliding piece 151. To this end, the clamping wedge 150 is in connection with the sliding piece 151 and/or the basic body 140 through an inclined bearing surface.

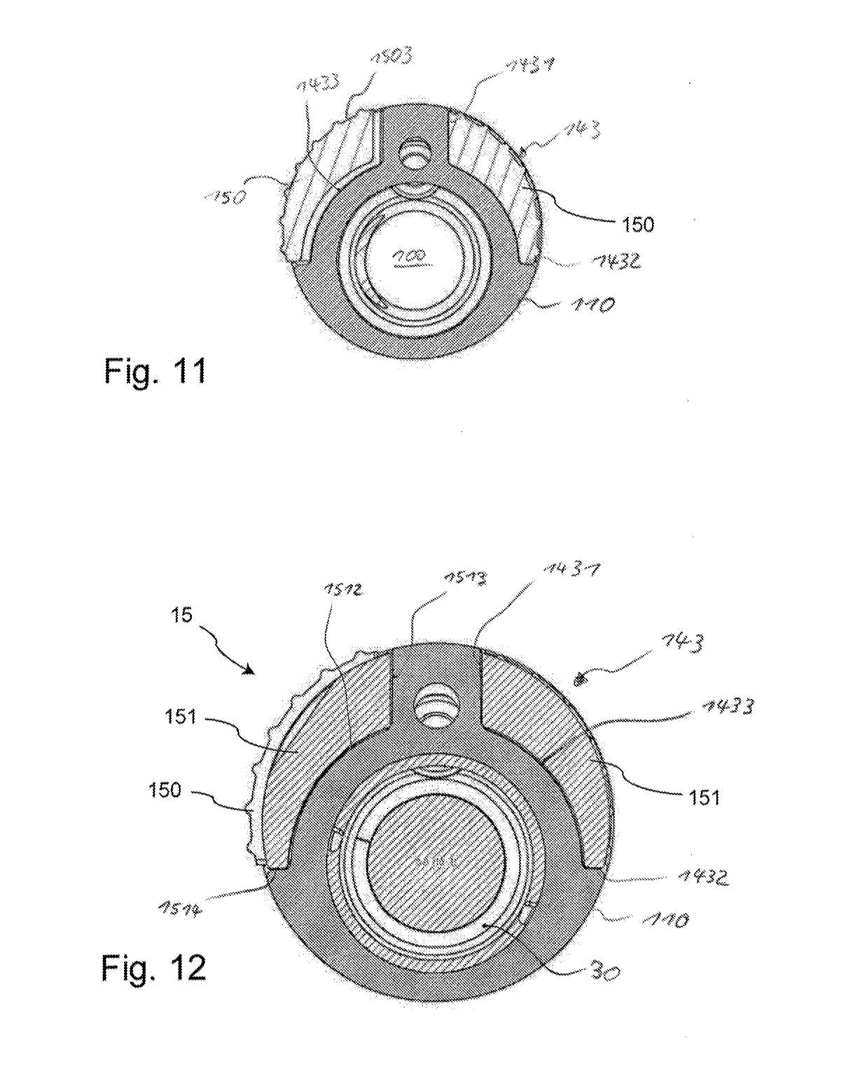

Both the sliding piece 151 as well as the clamping wedge 150 are disposed in a recess 143 of the clamping part 110 of the basic body 140. As is shown in the sectional representations in FIGS. 11 and 12, both the clamping wedge 150 as well as the sliding piece 151 have an outer contour that substantially fill out the recess 143 completely, so that a cylindrical outer contour of the clamping part 110 is obtained. Through axial displacement of the sliding piece 151, the clamping wedge 150 is guided against at least one inclined bearing surface so that the clamping wedge 150 partially emerges from the recess 143 and, thus, the outer contour of the clamping piece 110 is enlarged. An axial displacement in terms of the present description is to mean a displacement along the longitudinal extension of the clamping part 110.

At least one threaded pin 153 (see FIG. 13), for example in the form of a threaded rod or grub screw, can serve for displacing the sliding piece 110 in one exemplary embodiment of the invention. Each threaded pin 153 is inserted in an associated threaded bore of the basic body 140 and forms a variable stop for the sliding piece 151, as is described above on the basis of the leaf spring 115. The face end of the threaded pin 153 can be accessible from the outside, in order to make possible an adjustability of the clamping force following the insertion of the clamping part 110 in the handlebar tube 2. In some embodiments of the invention, the threaded pin 153 can be in contact with the sliding piece 151 through a cylindrical pin 152 (see FIG. 13). The cylindrical pin 152, because of the absent thread, can have a smaller outer diameter than the threaded pin 153 with the same strength, so that with restricted installation space a greater force can be transmitted from the threaded pin to the sliding piece 151 or, with predefined force, a more delicate embodiment of the basic body 140 and/or a larger sliding piece 151 can be selected.

As already described above on the basis of the leaf spring 115, the clamping part 110 according to the second embodiment can be provided with a single clamping device 15 or with a plurality of clamping devices. Shown is an embodiment having two clamping devices, without the invention being restricted to this number. Each clamping device 15 is assigned a threaded pin or a cylindrical pin 153 and 152, so that in FIG. 13 two of these elements each are also depicted.

FIG. 11 shows the cross-section through the clamping part 110 with the cylinder bore 100 disposed therein. As is shown on the basis of FIG. 10, the section according to FIG. 11 shows a longitudinal portion of the clamping part 110 with the clamping wedge 150. The clamping wedge 150 is in a recess 143 of the clamping part 110 or of the basic body 140. The cross-section of the clamping part 150 is shaped approximately complementarily to the cross-section of the recess 143, so that the clamping wedge 150 can be completely received in the recess 143. This situation is shown in FIG. 11 for the right clamping wedge 150. The clamping wedge 150 can then bear with its inner surface against the base area 1433.

By displacing the sliding piece 151, the effective length of the recess 143 becomes shorter, so that the clamping wedge 150 partially emerges from the opening 143. This situation is shown in FIG. 11 for the left clamping wedge 150. Because of this, the outer surface 1503 can be guided against the interior of the handlebar tube 2 to generate a clamping force there.

FIG. 12 shows the cross-section of the clamping part 110 in a longitudinal portion located further outside, i.e., a section through the sliding piece 151. Again, the left clamping wedge 150 is shown in a clamping position and the right clamping wedge 150 in a released position, as is explained above on the basis of FIG. 11. The sliding piece 151, too, has a shape that is substantially complementary to the recess 143. Because of this, the sliding piece 151 is axially displaceable in the recess 142 and radially fixed through positive connection. By exerting an axially acting force on the sliding piece 151, for example, through the threaded pins 153 and the cylindrical pins 152, the position of the sliding piece 151 in the recess 143 can be changed. Because of this, the effective length of the recess 143 changes, so that the clamping wedge 150 slides up and emerges from the recess 143.

The recess 143 has a cross-section that is substantially in the shape of an annulus sector. In some exemplary embodiments, the load receiving areas 1431 and 1432 can deviate from the exactly radial direction and, for example, enclose an angle of approximately 10° to approximately 30° to the radial direction. The base area 1433 of the recess 143 in some embodiments can have a smaller radius than the inner surface 1512 of the sliding piece 151 so that an air gap is formed between the inner surface 1512 and the base area 1433. Forces that are radially directed to the inside and act on the sliding piece 151 are, thus, exclusively removed from the sliding piece 151 to the basic body 140 through the lateral surfaces 1513 and 1514 and the load receiving areas 1431 and 1432. The cylinder wall of the cylinder bore 100 located below the base area 1433 with the piston 30 disposed therein is, thus, not loaded by these forces. Because of this, the cylinder bore 100 can be embodied larger or the cylinder wall thinner.

As is evident on the basis of FIGS. 9 and 13, the clamping wedge 150 can be fixed with an optional spring clip 155. On the one hand, this facilitates the assembly because the clamping wedge 150 cannot fall out of the recess 143, for as long as the clamping part 110 is not yet inserted in a handlebar tube 2. On the other hand, the spring clip 155 can exert a resetting force on the clamping wedge 150 so that, when retracting the sliding piece 151, the clamping wedge 150 is guided back into the recess 143. Any undesirable jamming or self-locking is, thus, avoided. To make possible an axial movement of the clamping wedge 150 in the recess 143, the groove 1505 in the clamping wedge 150 can have a greater width than the spring clip 155.

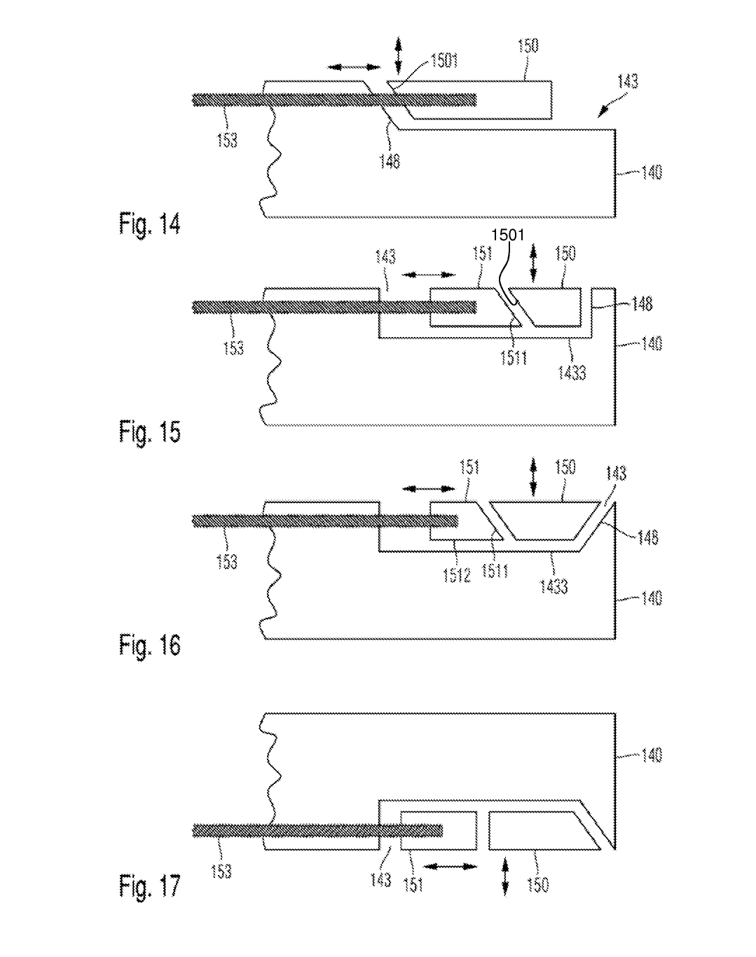

The mode of operation and different variants of the clamping device 15 according to the second embodiment are schematically explained in the following on the basis of FIGS. 14 to 17. In each case, the basic principle lies in displacing the clamping wedge 150 axially, i.e., in the direction of the longitudinal extension of the clamping part 110, as is indicated by the horizontal double arrow. Because the clamping wedge 150 is in contact with the sliding piece 151 through at least one inclined bearing surface 1501 with a likewise inclined surface 148 on the basic body 140 or an inclined contact surface 1511, this axial displacement leads to a radial movement, as is explained by the vertical double arrow.

In the embodiment according to FIG. 14, the clamping wedge 150 is moved against the sliding surface 148 by a threaded pin 153. This leads to a sliding-up of the clamping wedge 150 on the sliding surface 148 and, subsequently, to the generation of a clamping force. To this end, the threaded pin 153 is guided in the basic body 140 in an oversized bore, wherein a thread is present in the clamping wedge 150.

In the embodiment according to FIG. 15, the clamping wedge 150 is inserted in a recess 143 of the basic body 140. The effective length of the recess 143 is influenced through a displaceable sliding piece 151, wherein the clamping wedge 150 is prevented from axially exiting the recess 143 by a perpendicular sliding surface 148. By way of the contact surface 1511 and the bearing surface 1501, the clamping wedge 150 is pushed out of the recess 143 in the radial direction.

The embodiment according to FIG. 16 has a similar mode of operation as the embodiment according to FIG. 15. However, the sliding surface 148 is also inclined here so that the clamping wedge 150 can slide up on the sliding piece 151 and the recess 148 of the basic body 140 on both sides. Because of this, the actuating forces are reduced or the clamping forces increased with identical actuating force.

FIG. 17 shows the kinematic reversal to the embodiment according to FIG. 15. Here, the sliding piece 151 with the clamping wedge 150 is in engagement with a surface that stands approximately orthogonally to the movement direction, whereas the clamping wedge 150 slides up on an inclined sliding surface 148 on the basic body 140.

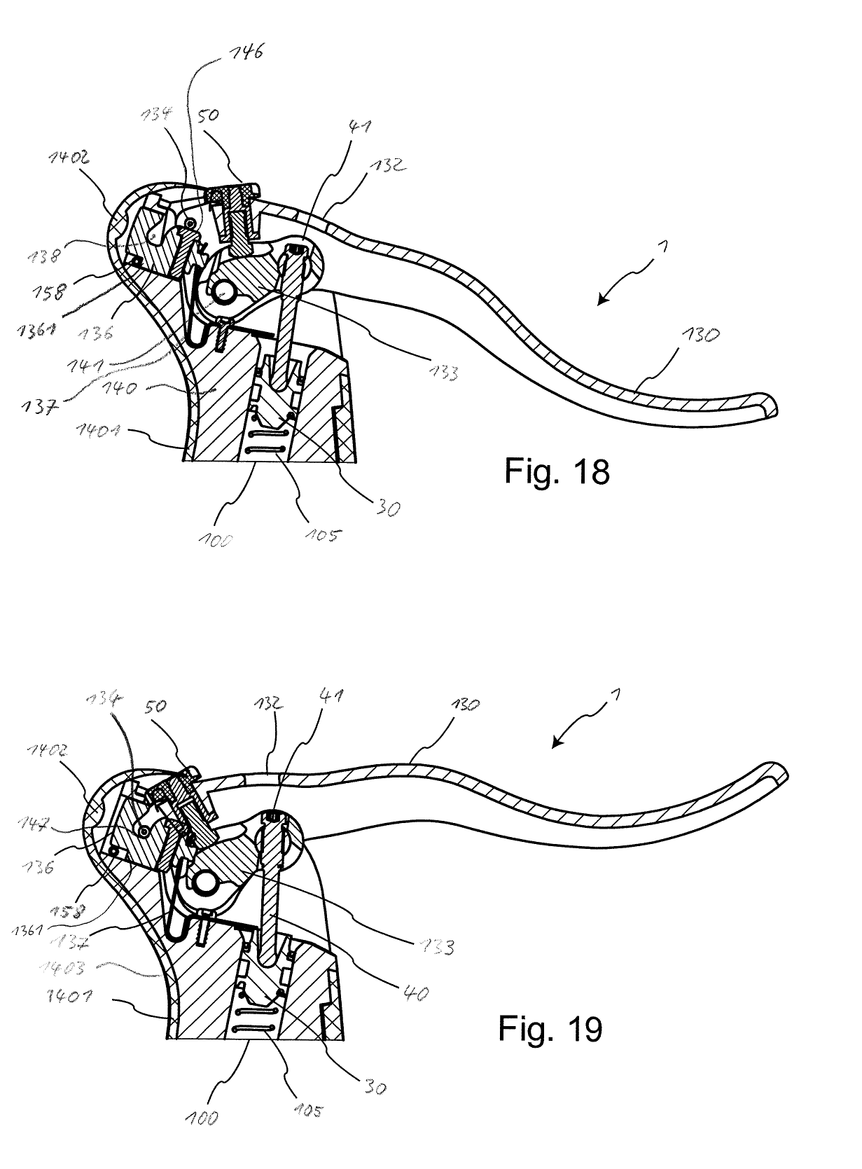

On the basis of FIGS. 18 and 19, a third exemplary embodiment of the master according to the invention is explained. Identical parts are provided with the same reference numbers, so that the following description is restricted to the essential differences.

The master 1 has the shape of a brake grip for handlebar-guided vehicles known per se. This means that the master 1 can be fastened to the handlebar tube with the side of the basic body 140 located opposite the hand lever 130, for example, with a clamp. Insofar as the master 1 is fastened to a racing handlebar, the hand lever 130 can point downwards, so that a concave grip surface 1403 facing up is offered for the hand of the user. At least the basic body 140 can be provided with a grip sheathing 1401 made of an elastic material, for example, a rubber.

As described above, the cylinder 100 with the piston 30 mounted therein in a sliding manner is located in the basic body 140, which piston is pushed into its rest position by a spring 105, i.e., a position in which the slave connected to the master 1 is likewise in the rest position. In the case of a brake, this is the opened position during which the wheel can rotate freely.

The master 1 comprises a hand lever 130, which is rotatably or pivotably received on the basic body 140 by an axle 141. On actuating the hand lever 130, the force exerted by the user acts on a thrust piece 133, in which the push rod 40 is received. The push rod 40 transmits the force onto the piston 30 so that the hydraulic actuating element can be operated. As described above, the rest position can be adjusted by turning the push rod 40. To this end, the tool receptacle 41 is accessible through an opening 132 in the hand lever 130. Because of this, an initial adjustment of the hydraulic actuating element and/or a readjustment upon wear of a friction lining can take place.

FIGS. 18 and 19 show an optional spindle 50. Through this spindle 50, the hand lever 130 is in contact with the thrust piece 133. The spindle 50 can be provided with a knurled head, which allows a turning or adjusting of the spindle 50 by the user without tools. Because of this, a lining readjustment without tools can be realized while driving, in that the angular position of the thrust piece 133 and, thus, the position of the piston 30 is influenced.

The hand lever 130 furthermore comprises a stop pin 134. As is evident from FIG. 18, the stop pin 134 bears against a first stop 146 in the first position, which is the operating position of the hand lever 130, which stop is formed on the outer contour of a moveable stop element 136. The first stop 146 can be provided with an optional screw, with which the grip width of the hand lever 130 can be adjusted. The moveable stop element 136 is held in the position shown in FIG. 18 by a spring 137. In this position, a protrusion 1361 of the moveable stop element 136 can bear against a pin 158 disposed in the housing 140 of the master 1.

To bring the hydraulic actuating element from the operating position into the second position or maintenance position (which, for example, allows a simple wheel change), the stop element 136 is transferred by the user through the longitudinal portion 1402 of the grip sheathing 1401 against the spring force of the spring 137 into the position shown in FIG. 19. This results in the stop pin 134 sliding into the groove 138 introduced in the stop element 136 and bearing against the second stop 147 on the base of the groove 138. Through the piston 30 and the push rod 40, the hand lever 130 reaches a second position further distant from the handlebar tube through the force of the spring 105. This position can be defined by the bearing of the piston 30 against a longitudinal portion of the spring element 137 partially covering the cylinder bore 100. During the next actuation of the hand lever 30, the stop element 136 is released by the stop pin 134 and guided against the pin 158 by the spring element 137, so that the master 1 again assumes the operating position shown in FIG. 18.

The solution principle disclosed in the above description also allows modifications without leaving the general inventive idea. The above description must therefore not be seen as restrictive, but as explanatory. The following claims must be understood so that a mentioned feature is present in at least one embodiment of the invention. This does not exclude the presence of further features. Insofar as the claims and the description define “first”, “second” and “third” features, this designation serves for the distinction of equivalent features, without establishing a sequence of rank.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

We claim:

1. A master for a hydraulic actuating element, comprising:
a piston;
a basic body defining a cylinder in which the piston is displaceably mounted;
a hand lever with which a position of the piston in the cylinder is influenced; and
a fastening element configured to fasten the basic body to a handlebar of a handlebar-guided vehicle, the handlebar having an inner cross section, the fastening element comprising a clamping part shaped complementarily to the inner cross section and configured to be fastened in the handlebar by internal clamping.

2. The master according to claim 1, wherein:
the clamping part has a circumferential surface; and
the fastening element has at least one clamping device imparting the internal clamping and is disposed on the circumferential surface of the clamping part.

3. The master according to claim 2, wherein:
the basic body has at least one sliding surface; and
the at least one clamping device contains at least one clamping wedge in contact with the at least one sliding surface on the basic body.

4. The master according to claim 3, further comprising at least one sliding piece displaceable in an axial direction and in contact with the clamping wedge.

5. The master according to claim 4, wherein:
the clamping part has a longitudinal axis; and
the sliding surface is inclined against the longitudinal axis of the clamping part to subject the clamping wedge to a radial position change during an axial displacement on the sliding surface.

6. The master according to claim 4, wherein the sliding piece is in contact with the clamping wedge through an inclined contact surface to subject the clamping wedge to a radial position change during an axial displacement of the sliding piece.

7. The master according to claim 6, wherein:
the clamping part has a longitudinal axis; and
at least one of the contact surface and the sliding surface is inclined against the longitudinal axis of the clamping part by one of:
approximately 15° to approximately 60°; and
approximately 25° to approximately 35°.

8. The master according to claim 4, further comprising at least one adjusting device by which an axial position of at least one of the clamping wedge and the sliding piece can be influenced after the clamping part has been inserted in the handlebar.

9. The master according to claim 8, further comprising a cylindrical pin; and
the basic body having a threaded bore;
the adjusting device comprising a threaded pin in the threaded bore; and
force transmission from the threaded pin to at least one of the clamping wedge and the sliding piece being effected through the cylindrical pin.

10. The master according to claim 4, wherein the basic body comprises at least one recess in which at least one of the clamping wedge and the sliding piece is received.

11. The master according to claim 3, further comprising a spring clip with which exerts a spring force acting at least in a radial direction on the clamping wedge.

12. The master according to claim 10, wherein:
the clamping part has a substantially cylindrical basic shape;
the recess has:
a cross section delimited by two load receiving areas running substantially radially; and
a base area with a first radius;
the sliding piece has a cross section in at least one longitudinal portion with the shape of an annulus sector whose inner surface has a second radius, the second radius being smaller than the first radius.

13. The master according to claim 1, wherein the clamping part has a circumferential surface and further comprising at least one leaf spring imparting the internal clamping and being disposed on the circumferential surface of the clamping part.

14. The master according to claim 13, further comprising at least one adjusting device by which a preload of the leaf spring can be influenced after the clamping part has been inserted in the handlebar.

15. The master according to claim 1, wherein:
the clamping part has an interior; and
the cylinder is at least partially disposed in the interior of the clamping part.

16. The master according to claim 1, further comprising a hydraulic line connection on the clamping part.

17. The master according to claim 1, further comprising a moveable stop element, the hand lever comprising:
a first stop defined by a first position of the moveable stop element; and
a second stop defined by a second position of the moveable stop element.

18. A master for a hydraulic actuating element, comprising:
a piston;
a basic body defining a cylinder in which the piston is displaceably mounted;
a moveable stop element having first and second positions with respect to the basic body;
a hand lever with which a position of the piston in the cylinder is influenced, the hand lever comprising:
a first stop defined by the first position of the moveable stop element; and
a second stop defined by the second position of the moveable stop element; and
a fastening element configured to fasten the basic body to a handlebar of a handlebar-guided vehicle.

19. The master according to claim 18, wherein the cylinder has a first volume when the hand lever is located on the first stop and a second volume when the hand lever is located on the second stop.

20. The master according to claim 19, wherein the second volume is larger than the first volume so that the hand lever has different rest positions when bearing against the first or against the second stop.

21. The master according to claim 18, further comprising a first spring element acting on the stop element and, during a movement of the hand lever from the second stop to the first stop, brings the stop element from the second position into the first position.

22. The master according to claim 18, wherein the hand lever has an internal thread and further comprising a push rod:
connecting the hand lever to the piston; and
comprising a first longitudinal portion provided with an external thread that engages in the internal thread on the hand lever so that a distance between the piston and the hand lever can be adjusted by turning the push rod.

23. The master according to claim 22, further comprising at least one second spring element, the push rod comprising a second longitudinal portion provided with a polygonal shaped outer cross-section bearing against the at least one second spring element.

24. The master according to claim 23, wherein the second spring element contains at least one leaf spring.

25. The master according to claim 18, wherein the hand lever has an axle and is rotatably mounted on the basic body, the axle being received in an elongated hole of the basic body.

26. The master according to claim 22, further comprising a thrust piece on which force exerted by the hand lever is acting and in which the push rod is received.

27. The master according to claim 26, further comprising a spindle through which the hand lever is in contact with the thrust piece.

28. The master according to claim 21, wherein a longitudinal portion of the first spring element at least partially moving the cylinder forms a stop for the piston when the hand lever bears against the second stop.

29. The master according to claim 18, wherein:
the piston seals off the cylinder to the outside with a wiping lip and is produced from a plastic material; and
the wiping lip is unitarily joined to the piston.

30. A master for a hydraulic actuating element, comprising:
a piston being of a plastic material and having a unitarily joined wiping lip;
a basic body defining a cylinder in which the piston is displaceably mounted, the piston sealing off the cylinder to the outside with the wiping lip; and
a hand lever with which a position of the piston in the cylinder is influenced.

31. The master according to claim 30, wherein the piston is of at least one of polyoxymethylene, polyethylene, polyether ketone, and polytetrafluoroethylene.

32. The master according to claim 1, wherein the master is for one of a disk brake, a rim brake, and a clutch.

33. The master according to claim 1, wherein the master is for at least one of a bicycle, a recumbent bicycle, a scooter, and a tricycle.
